(19) United States
(12) Patent Application Publication
(10) Pub. No.: US 2007/0289202 A1
(43) Pub. Date: Dec. 20, 2007

(54) Method and apparatus for abating insects

(76) Inventor: Bill L. Spencer, Roswell, GA (US)

Correspondence Address: ADORNO & YOSS, LLP, 1233 20th Street, NW, SUITE 703, WASHINGTON, DC, 20036, US

(21) Appl. No.: 11/437,869

(22) Filed: May 22, 2006

Related U.S. Application Data
(60) Provisional application No. 60/697,983, filed on Jul. 12, 2005.

(51) Int. Cl. A01M 1/20

(52) U.S. Cl. 43/131

(57) ABSTRACT

A method and apparatus for abating insects in an efficient, cost effective and environmentally pleasing manner is disclose. In one embodiment, the apparatus is formed of an exterior hollow and perforated pipe-like structure that can be made in various lengths and widths depending on its application. The outer structure holds the interior components of the device and serves as a means for attaching the device to a support structure, such as a fence, the ground or other surface. The outer structure also allows the device to be suspended from its support structure where circumstances make hanging of the device a more desirable installation. In another embodiment, a plurality of bait stations is provided. The bait stations may be jointed together end to end to form the apparatus.

### REFERENCE TO RELATED APPLICATION

This application claims priority to provisional patent application Ser. No. 60/697,983 filed on Jul. 12, 2005 and entitled “Method and Apparatus for Abating Flying Insects.”

### BACKGROUND OF THE INVENTION

The present invention generally relates to the field of insect control and more particularly, is directed to a method and apparatus for abating insects in an efficient, cost effective and environmentally pleasing manner.

Around humans and animals, insects present health and sanitation problems and generally are considered to be a nuisance. Thus, there have been many devices and methods developed to control their numbers. It is well known that many kinds of insects can be killed by being attracted to a sticky surface upon which they then become stuck and die. Fly paper is one example of this method of insect control.

A disadvantage associated with insect control devices and traps of this type, however, is that the adhesive characteristics of the sticky surface usually diminish over time. Also, such insect traps become unsightly due to the concentration of dead insects on the sticky surface. Thus, insect traps of this type require periodic maintenance by replacing the insect trap entirely or by replacing the portion of the trap that bears the sticky substance. It is readily apparent that the appearance and disposal of adhesive trapping devices of this type can be a rather unpleasant experience.

It is also is known that various light sources can be used to attract insects. Accordingly, a number of insect trapping devices have been developed which combine the use of attractant light and a sticky surface to trap the insects. Such devices are disclosed, for example, in U.S. Pat. Nos. 5,651,211, 5,513,465, 5,505,017, 5,425,197, 5,251,397, and 4,074,457. While some of these devices have gained wide acceptance, they also suffer from inefficiencies and disadvantages. For example, many of these types of devices are designed for continuous use and thus consume electricity even when pest control is not needed. In addition, installation in an outdoors environment requires special precautions with respect to waterproofing and the danger of electrical shock.

Some geographical areas, particularly areas which experience temperatures below freezing during portions of the year, have insect populations which are seasonal. In such areas, insect traps may not be needed for large portions of the year. Similarly, cabins, outdoor porches, gazebos, shelters in public parks, portions of restaurants or other facilities used for wedding receptions and the like, or other entertaining or living spaces, may be used on a seasonal, intermittent, or temporary basis. In such settings, insect traps may be required only when those spaces are in use.

The nature of some geographic areas are also particularly conductive to the breeding of insects and thus requires constant vigilance in order to keep them in check. For example, flies are a major problem on farms and other places where animals and pets live out of doors and in close proximity to humans. Animal waste, and the generally unsanitary state of large animals—such as cows, horses and other farm animals, attract flies and promote their breeding. Due to their mobility and scavenger nature, flies are a major factor in the spreading of germs, bacteria and disease. The same could be said for mosquitoes and other flying insects that frequent places where humans are present. Mosquitoes are of particular concern because of their ability to spread serious diseases through mosquito bites.

In order to address the need for insect control, some insect traps, especially those which require electrical power, are permanently installed. For example, insect traps may be mounted on a pole when installed in an outdoor area, or affixed to a wall with screws or other mounting hardware when installed in an indoor area. Insect traps which require permanent or semi-permanent installation are not as well suited for seasonal or intermittent use as an insect trap which can be easily installed when needed and easily removed when not needed. Further, insect traps which require permanent or semi-permanent installation may require alteration of the walls onto which they are mounted, making such traps unsuitable for temporary use, as for example when used in a public shelter house or in a space which is rented for a short period of time.

While other insect traps, for example fly paper, may be suitable for temporary, seasonal, or intermittent use, the unsightly appearance of dead insects in such traps diminishes their usefulness. This is especially so in places used for dining or entertaining, such as restaurants, reception halls, and the like.

There also are other attempted control measures available in the art, such as liquid chemicals disbursed through tubes. The disadvantage of these approaches is that they must be sprayed on animals and humans which can lead to a host of related medical problem.

### SUMMARY OF THE INVENTION

For the foregoing reasons, there is a need in the art for an improved insect abatement device which solves the problems associated with prior art devices as explained above.

It is therefore a primary objective of the present invention to provide an improved device for controlling insects which is easy to maintain and does not present an unpleasant experience when being serviced.

It is a further objective of the present invention to provide an improved device for controlling insects which does not rely on electricity or any other power source.

It is a still further objective of the present invention to provide an improved device for controlling insects which provides for increased operating efficiencies.

It is another objective of the present invention to provide an improved device for controlling insects which can be easily mounted in a permanent location or removablely mounted for temporary use.

It is a still further objective of the present invention to provide an improved device for controlling insects which can be easily and economically manufactured.

It is another objective of the present invention to provide an improved device for controlling insects in which the bait supply can be replenished without exposing the user to any harmful effects of the bait supply.

It is another objective of the present invention to provide an improved device for controlling insects in which the device is integrally formed with the bait supply.

It is another objective of the present invention to provide an improved device for controlling insects in which the device is formed separately from and independent of the bait supply.

It is another further objective of the present invention to provide an improved device for controlling insects and is particularly adapted for flying insects.

The above and other objectives of the present invention are achieved by a device for abating insects that is formed of an exterior hollow and perforated pipe-like structure that can be made in various lengths and widths depending on its application. The outer structure holds the interior components of the device and serves as a means for attaching the device to a support structure, such as a fence, the ground or other surface. The outer structure also allows the device to be suspended from its support structure where circumstances make hanging of the device a more desirable installation.

In one embodiment of the invention, an internal hollow and perforated pipe-like carrier is provided for containing an abatement chemical. The carrier may be made in various lengths and widths, depending on its application. In an alternative embodiment, a plurality of bait trays is provided. These two embodiments allow the device to either be preloaded with bait at the time of its distribution, or loaded with bait in the field once the device is installed.

The concentrically arranged outer and inner pipe structures with their respective perforations that form entry ways allow flying insects to enter the device and feed on the bait material. The bait material contains a toxin which, depending on its type and concentration, kills the insect instantly upon contact or ingestion. The dead insects then fall to the bottom of the device for later removal or directly to the ground through an opening in the bottom to decay into the soil.

Some bait materials are more suitable for social insects. Social insects are those that live in colonies and exhibit characteristics of grooming, trophallaxis (exchanging gut contents), palpation and antennation. Insects that exhibit these behaviors include wasps and honey bees. Baits that are designed for the control of social insects have a slow acting toxicant that is non-repellant to the insect upon first contact. The social behavior of these types of insects lead to transmission of the toxic ingredient in the bait throughout the population, thus ultimately killing a more substantial number of insects than would be possible using kill-on-contact types of bait.

The selection of the proper bait is well within the knowledge of a person having ordinary skill in the art, taking into consideration, for example, the type and number of insects to be controlled and the install location of the device.

### BRIEF DESCRIPTION OF THE DRAWINGS

These and other features, aspects, objectives, and advantages of the present invention will become better understood upon consideration of the following detailed description, appended claims and accompanying drawings where:

FIG. 1 is a schematic view of the exterior of a device for abating insects in accordance with one embodiment of the present invention;

FIG. 2 is cross-sectional view taken along line 2-2 in FIG. 1;

FIG. 3 is a partial schematic view of a device for abating insects in accordance with the embodiment of the present invention illustrated in FIG. 1, showing an alternative arrangement of bait access ports;

FIG. 4 is a partial schematic view of a device for abating insects in accordance with the embodiment of the present invention illustrated in FIG. 1, showing a further alternative arrangement of bait access ports;

FIG. 5 is partial schematic view of a bait carrier for a device for abating flying insects in accordance with the embodiment of the present invention illustrated in FIG. 1, showing an alternative system for mounting the device to the ground;

FIG. 6 is a schematic view of a bait carrier for a device for abating flying insects in accordance with the embodiment of the present invention illustrated in FIG. 1;

FIG. 7 is cross-sectional view taken along line 7-7 in FIG. 6;

FIG. 8 is cross-sectional view taken along line 7-7 in FIG. 6;

FIG. 9 is cross-sectional view taken along line 2-2 in FIG. 1;

FIG. 10 is cross-sectional view taken along line 2-2 in FIG. 1;

FIG. 11 is cross-sectional view taken along line 2-2 in FIG. 1;

FIG. 12 is a schematic view of the exterior of a device for abating insects in accordance with a further embodiment of the present invention;

FIG. 13 is a schematic view of the exterior of a device for abating flying insects in accordance with a still further embodiment of the present invention;

FIG. 14 is a schematic view of a bait carrier tray for holding bait material in accordance with the present invention;

FIG. 15 is a cross-sectional view taken along line 15-15 in FIG. 14;

FIG. 16 is schematic view of a plurality of bait carrier trays in a stacked configuration in accordance with the present invention;

FIG. 17 is schematic view of another embodiment of the present invention showing a plurality of bait stations;

FIG. 18 is a cross-sectional view of one of the bait stations illustrated in FIG. 17;

FIGS. 19 and 20 are bottom and top views of the bait stations illustrated in FIG. 17;

FIG. 21 is a cross-sectional view of the mounting bracket for the embodiment of the invention shown in FIG. 17;

FIGS. 22 and 23 are top and bottom views of the mounting bracket shown in FIG. 21; and

FIG. 24 is an end view of the mounting bracket shown in FIG. 21.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should also be understood, of course, that the invention is not necessarily limited to the particular embodiments illustrated herein.

Like reference numerals will be used to refer to like or similar parts from Figure to Figure in the following description of the drawings.

### DESCRIPTION OF THE PREFERRED EMBODIMENT

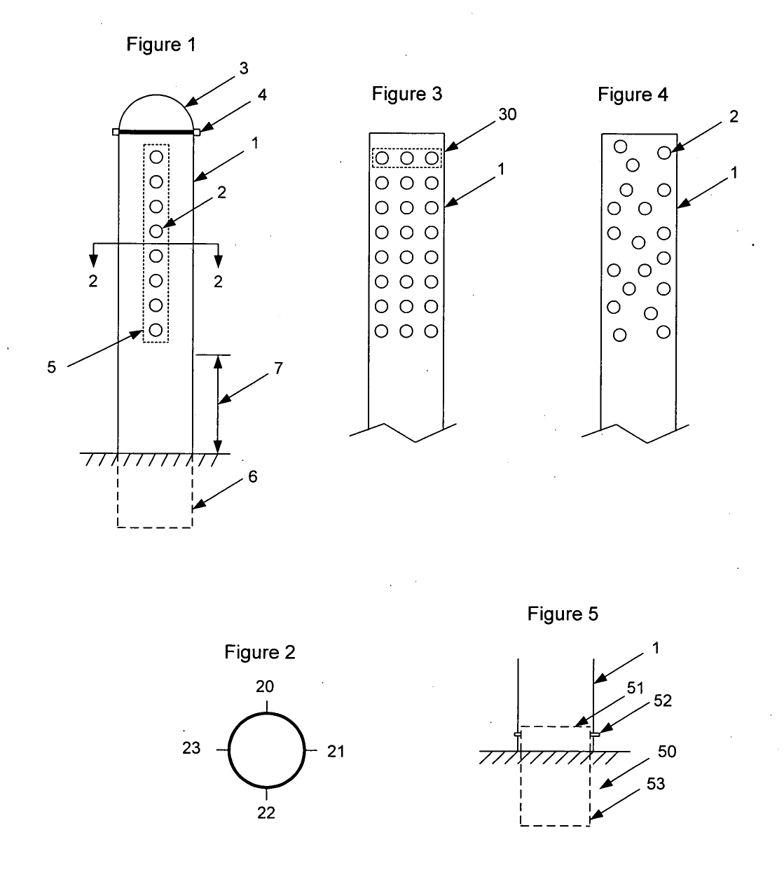

A description of the preferred embodiment of the invention will now be described with reference to the accompanying drawings in which FIG. 1 is an exterior view of an device for abating insects in accordance with the present invention.

As illustrated in FIG. 1, the device apparatus of this embodiment of the invention is formed of an elongated hollow outer housing 1 of circular construction. Housing 1 includes a plurality of bait access ports 2 which permit flying insects to gain access to the internal bait.

Bait access ports 2 within outer housing 1 may be formed in a plurality of sizes and shapes, but it has been found that a circular hole of approximately 1 ½ inches in size works well. Other sizes for bait access ports 2 may be used as well. The size of the ports should be sufficiently large so that insects will have no difficulty entering the device.

Housing 1 is terminated at an upper end by removable cap 3 which permits access to the interior of housing 1 for loading the abatement device with a bait carrier as shall be described below. Cap 3 can be held and secured to housing 1 by a number of fastening devices known in the prior art, including screws 4 as illustrated in FIG. 1.

As shown in FIG. 1, bait access ports 2 are vertically aligned and, depending on its intended install location, may be a single vertically aligned row 5 or a plurality of vertically aligned rows around the circumference of the outer housing 1 as illustrated in FIG. 2. FIG. 2 is a cross-section of outer housing 1 taken along lines 2-2 in FIG. 1. As shown in this figure, vertically aligned rows 5 are positioned at locations 20, 21, 22 and 23 around the circumference of outer housing 1.

Alternative arrangements for bait access ports 2 may also be used, such as the horizontally aligned multiple rows 30 illustrated in FIG. 3 and the random alignment of access ports 2 illustrated in FIG. 4. Similar to the number and arrangement of bait access ports shown in FIGS. 1 and 2, the number and arrangement of ports shown in FIGS. 3 and 4 may be left to the discretion of one of ordinary skill in the art.

In the embodiment of the invention shown in FIG. 1, the abatement device may be mounted into the ground or onto a ground mounting support 50 as shown in FIG. 5. When mounted into the ground, a portion 6 of outer housing 1 extends into the ground of sufficient depth to provide upright support for the device.

When mounted on the ground, a number of ground mounting techniques can be employed as known to those of skill in the art. In the example illustrated in FIG. 5, ground penetrating mounting support 50 serves as a mounting structure for outer housing 1. In this embodiment, support 50 includes an above ground portion 51 which extends into the inside of housing 1 and is secured thereto by one or more a fastening devices, such as bolts 52. A portion 53 of mounting support 50 extends into the ground of sufficient depth to provide upright support for the abatement device when it is attached to the support.

The length of outer housing 1 which extends above ground can be determined in relation to its intended install location, keeping in mind that the final installation should be such that children, small pets and the like will not be able to access the poisonous bait inside. Thus, some installations might require a space 7 between the surface of the ground and the first bait access port 2 as shown in FIG. 1. Some amount of space 7 also should be present in order to prevent surface water from entering the bait access ports.

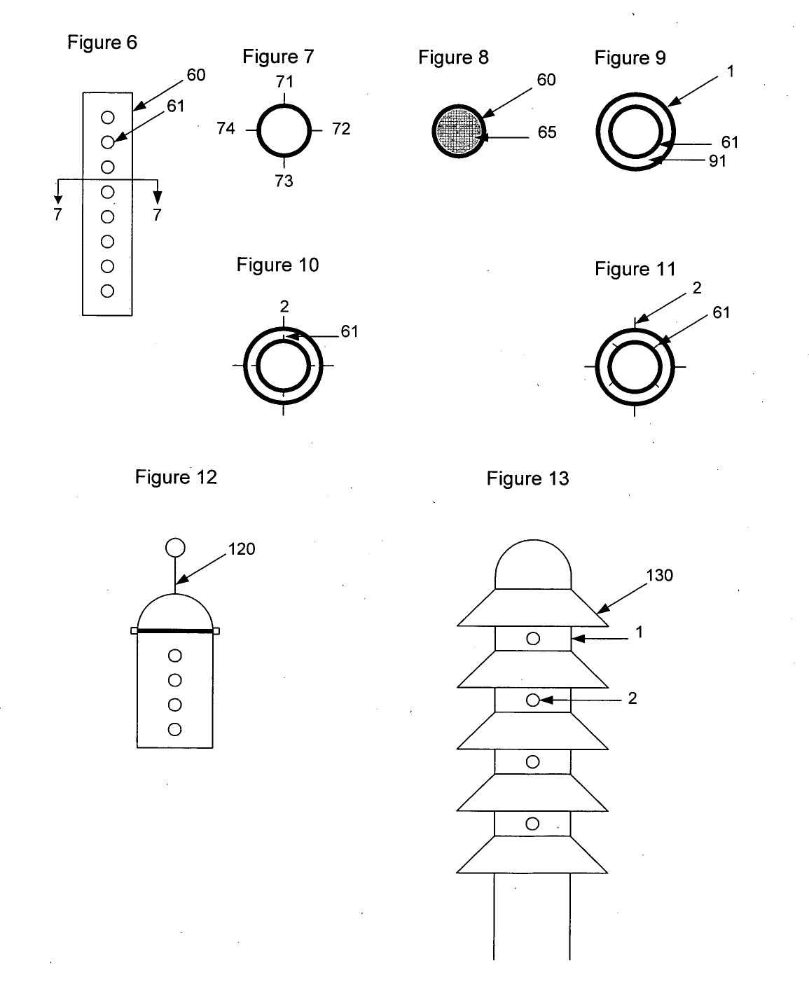

A bait carrier 60 is contained within housing 1. Bait carrier 60 is illustrated in FIG. 6 and like housing 1, is of elongated and hollow circular construction. Carrier 60 includes a plurality of bait holes 61. As shown in FIG. 6, bait holes 61 are vertically aligned and, depending on the intended use and location of the abatement device, may be formed of a single vertically aligned row or a plurality of vertically aligned rows around the circumference of carrier 60 as illustrated in FIG. 7.

FIG. 7 is a cross-section of carrier 60 taken along lines 7-7 in FIG. 6. As shown in FIG. 7, vertically aligned bait holes 61 may be positioned at locations 71, 72, 73 and 74. Alternative arrangements may also be used, such as in horizontally aligned multiple rows similar to the pattern illustrated in FIG. 3 or the random alignment pattern illustrated in FIG. 4, both with respect to bait access ports 2 of outer housing 1. The number and arrangement of bait holes 61 may be left to the discretion of one of ordinary skill in the art.

The interior of carrier 60 is filled with bait 65 as shown in FIG. 8. FIG. 8 is a further view of the cross-sectional taken along lines 7-7 in FIG. 6 illustrating the presence of bait 65 within carrier 60.

Bait holes 61 within carrier 60 may be formed in a plurality of sizes and shapes, but it has been found that a circular hole of approximately ¼ inch in size works well. Other sizes for bait holes 61 may be used as well. The size of bait holes 61 should be sufficiently large so that insects and pests at the exterior of carrier 60 can feed on the bait through bait holes 61. The size should not be so large, however, that bait 65 freely passes through the holes and falls out of carrier 60.

Carrier 60 is positioned and secured inside of housing 1 as illustrated in FIG. 9. FIG. 9 is a further view of the cross-sectional view taken along lines 2-2 of FIG. 1. This view shows that the outside diameter of carrier 60 is such that the carrier fits within outer housing 1 with a space 91 between the outside diameter of carrier 60 and the inside diameter of outer housing 1.

FIG. 10 is a further view of a cross-sectional taken along lines 2-2 of FIG. 1 showing bait holes 61 in carrier 60 aligned with bait access ports 2 in outer enclosure 1. FIG. 11 is a similar view showing bait holes 61 offset from bait access ports 2.

FIG. 12 illustrates a further embodiment of the present invention. This embodiment includes a hanger 120 for handing the abatement device from a support structure such as the side of a building. FIG. 13 is a still further embodiment of the present invention. In this embodiment, a plurality of flutes 130 is provided. Flutes 130 shield access ports 2 from the weather.

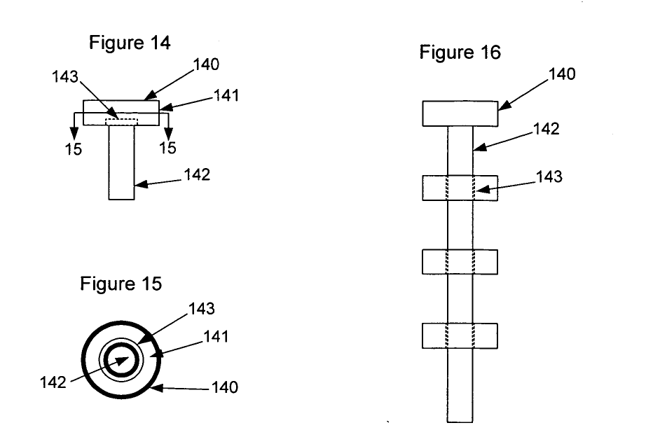

FIGS. 14-16 represent an alternative embodiment for carrier 60 illustrated in FIG. 6. In this embodiment, a carrier tray 140 is provided. The carrier tray is generally circular in construction and has a bait holding area 141 in which a supply of bait can be provided. The carrier tray also includes a stand 142. FIG. 15 is a cross-sectional view taken along lines 15-15 in FIG. 14. Carrier tray 140 and stand 142 are formed with a mating interface 143 such that a plurality of carriers trays can be joined to form a bait carrier unit as illustrated in FIG. 16.

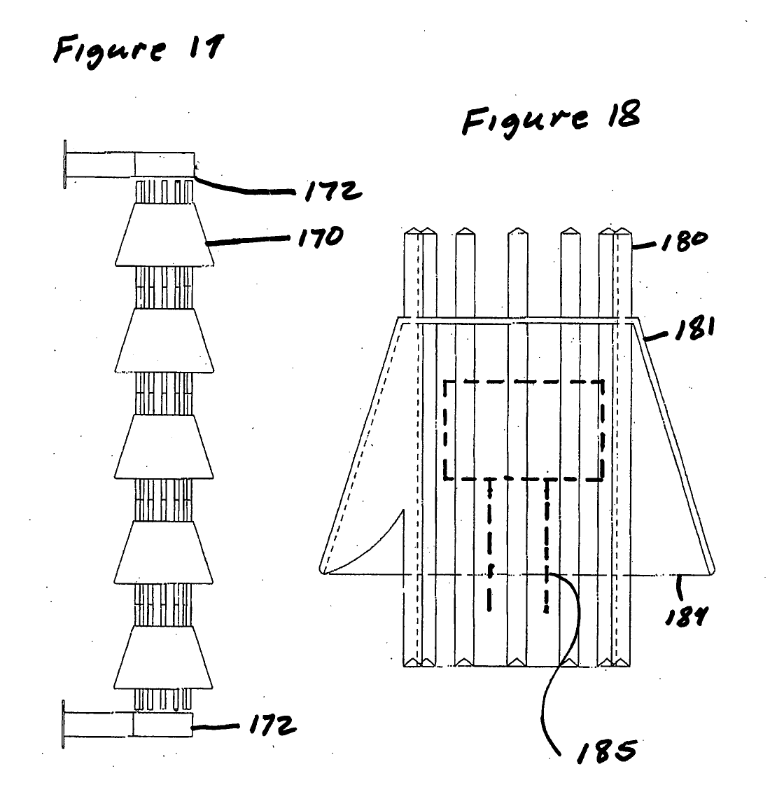

FIG. 17 is a further embodiment of the present invention. In this embodiment, a plurality of bait stations 170 are joined together to form a stack. As shown in FIG. 18, each bait station 170 includes a plurality of spacing rods 180 and a shield 181. FIG. 19 is a bottom view of bait station 170 showing spacing rods 180 arranged in a generally circular fashion around the interior of shield 181.

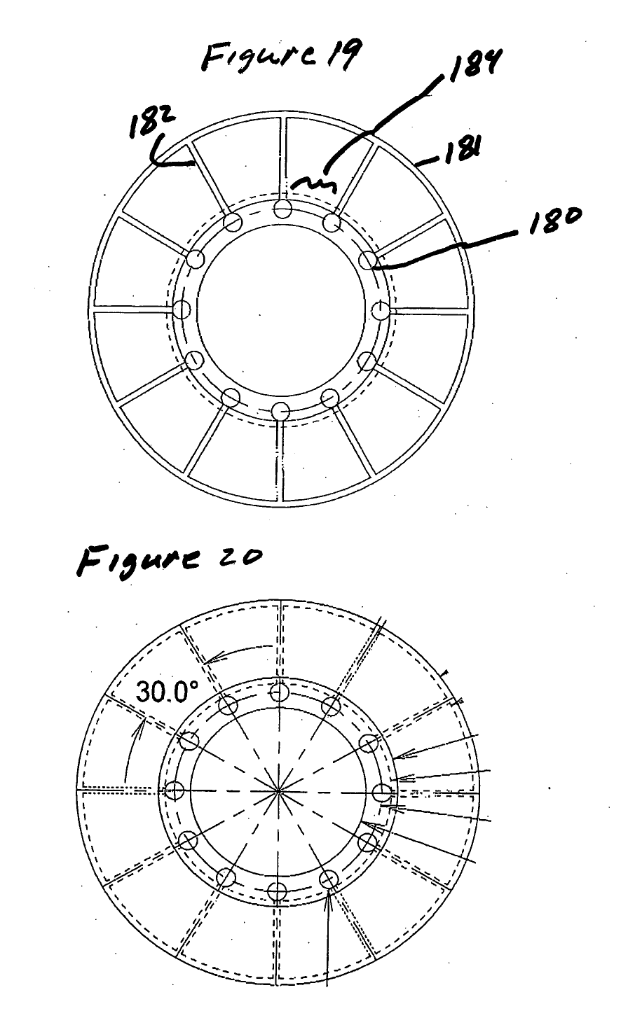

Note that shield 181 includes a plurality of internal strengthening ribs 182 which help to provide strength and form to the shield. As shown in FIG. 18, shield 181 is generally circular in shape with an upper diameter 183 that is smaller than lower diameter 184. This construction of shield 181 promotes flowing of water away from the bait station, thus limiting the likelihood of, for example, rain water from coming into contact with the bait. FIG. 20 is a top view, further illustrating the construction of bait station 170.

As illustrated in FIG. 18, bait station 170 is designed to accommodate a bait carrier tray 185 as shown in FIG. 16. Note that bait carrier tray 185 is surrounded by spacing rods 180. As illustrated in FIG. 19, spacing rods 180 are arranged with a space 184 between them. The size of space 184 should be chosen so that small pets and children can not gain access through spacing rods 180 to the bait carrier tray discussed below.

Bait stations 170 may be constructed in a number of ways, including injection molding as individual parts with respect to the shield 181 and spacing rods 180, or by injection molding as an integrally formed one-piece assembly.

With reference again to FIG. 17, the bait station stack is terminated at an upper end by an upper mounting bracket 172 and a lower mounting bracket 172. Brackets 172 can be used to mount the bait stack to a wall or other convenient mounting surface.

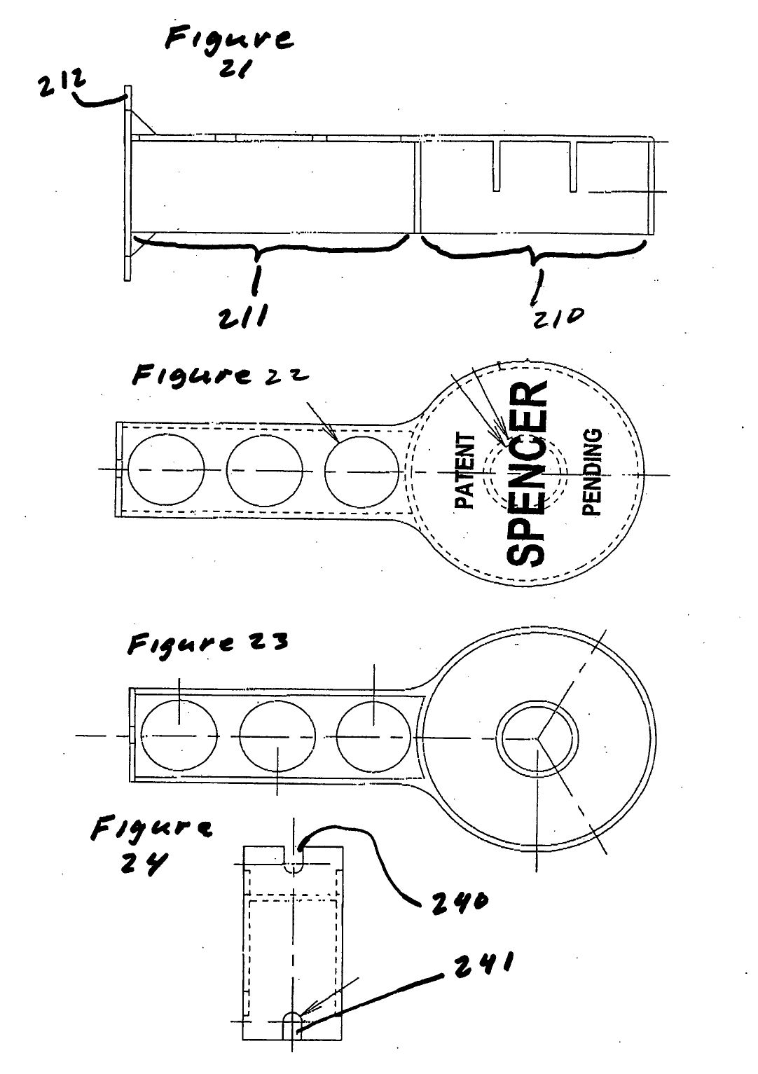

FIGS. 21-24 illustrate the construction of mounting bracket 172 in more detail. As shown in FIG. 21, bracket 172 includes a bait station receiving portion 210, a wall setoff portion 211 and a mounting plate 212. Receiving portion 210 holds the upper most bait station 170 in the stack in a secure position when the stack is mounted. The length of setoff portion 211 can adapted as needed to accommodate the surface to which the bait stack will be attached. Mounting plate 212 provides a mounting feature for attachment to the mounting surface.

FIGS. 22 and 23 are top and bottom views of bracket 172. FIG. 24 is an end view of mounting plate 240 showing screw slots 240 and 241.

Mounting bracket 172 is designed to be symmetrical so that it can be used for both an upper and lower mounting bracket as shown in FIG. 17. Receiving portion 210, illustrated in FIG. 21, holds the lower most bait station 170 in the stack in a secure position when the stack is mounted. Mounting bracket 172 may also be manufactured in a number ways, including injection molding.

The abatement device of the present invention is suited for most kinds of insects and pests but is particularly adapted for flying insects such as flies. It has been found that the invention greatly reduces the number and severity of fly infestation in such hard to control areas as farms and around farm animals. The problems noted above with respect to an unsightly accumulation of dead insects and less than preferred results are virtually eliminated by the present invention.

The baits that the present invention contemplates using are degraded by ultra-violet rays and water. The construction of the device of the invention, however, eliminates that degradation almost completely.

Although the present invention has been described in considerable detail with reference to certain preferred embodiments, one skilled in the art will appreciate that the present invention can be practiced by other than the preferred embodiments, which have been presented for purposes of illustration and not of limitation. Therefore, the spirit and scope of the appended claims should not be limited to the description of the preferred embodiments contained herein.

I claim:

1. An apparatus for abating insects, said apparatus comprising:
an elongated hollow outer housing having a plurality of bait access ports; and
an elongated hollow bait carrier positioned within said outer housing for carrying a bait material, said bait carrier having a plurality of bait holes through which said insects can feed on said bait material.

2. An apparatus for abating insects according to claim 1, wherein said bait access ports are arranged in a plurality of repeating patterns.

3. An apparatus for abating insects according to claim 1, wherein said bait access ports are arranged in a substantially random pattern.

4. An apparatus for abating insects according to claim 1, wherein said bait holes are arranged in a plurality of repeating patterns.

5. An apparatus for abating insects according to claim 1, wherein said bait holes are arranged a substantially random pattern.

6. An apparatus for abating insects according to claim 1, wherein said elongated hollow outer housing is adapted for mounting said apparatus to the ground.

7. An apparatus for abating insects according to claim 1, wherein said elongated hollow outer housing is adapted for mounting said apparatus on a surface.

8. An apparatus for abating insects according to claim 1, wherein said elongated hollow outer housing is adapted for suspending said apparatus in the air.

9. An apparatus for abating insects according to claim 1, further including a plurality of shields adapted for preventing rain water from entering said bait access holes, said shields being generally circular in shape and having a diameter at one end that is smaller than the diameter at the opposed end.

10. An apparatus for abating insects, said apparatus having at least one bait station comprising:
a plurality of spaced apart supports generally arranged in a circular pattern to form an open area; and
a shield positioned around said plurality of supports, said shield being generally circular in shape and having a diameter at one end that is smaller than the diameter at the opposed end; and
a bait carrier positioned within said open area and adapted for carrying a bait material.

11. An apparatus for abating insects according to claim 10, wherein said supports are rods.

12. An apparatus for abating insects according to claim 10, where said bait carrier includes a bait tray attached to an extension support, said bait tray and said extension support being adapted for mating to an adjacent bait carrier on each opposed ends of said bait carrier.

13. An apparatus for abating insects according to claim 10, further including respective upper and lower mounting brackets adapted for attachment to opposed ends of said bait station.

14. An apparatus for abating insects according to claim 13, wherein said upper and lower mounting brackets cooperate to allow said apparatus to be attached to a surface.

15. A method of abating insects, said method comprising the steps of:
providing an elongated hollow outer housing having a plurality of bait access ports; and
positioning within said elongated hollow outer housing an elongated hollow bait carrier containing a bait material;
providing a plurality of bait holes through which said insects can feed on said bait.

16. The method of claim 15, further including the step of:
providing a plurality of shields adapted for preventing rain water from entering said bait access holes.
